(19) United States
(12) Patent Application Publication
(10) Pub. No.: US 2012/0232960 A1
(43) Pub. Date: Sep. 13, 2012

(54) Method and system for pricing and exchange of datasets that includes multiple users contributing incremental improvements to increase the value and utility of the datasets

(76) Inventor: Stanley Benjamin Smith, Fort Mill, SC (US)

(21) Appl. No.: 13/200,073

(22) Filed: Sep. 16, 2011

Related U.S. Application Data
(63) Continuation-in-part of application No. 12/932,797, filed on Mar. 7, 2011.

(51) Int. Cl. G06Q 30/06; G06F 15/16

(52) U.S. Cl. 705/7.35

(57) ABSTRACT

The invention provides a method and system to enable incremental improvement and changes to datasets and the determination of values prices, auction minimums, or rewards or bounties for entering incremental changes to datasets. The invention includes art to enable simple secure attributable versioning of datasets, art to enable transfer of datasets through sale or other trading and exchange mechanisms, art to use the features capabilities and functions of websites servers social networking sites and Wiki or blog sites to rank reward and otherwise compensate users who contribute to incremental improvement of datasets, and art to tier service and access levels for access to or receipt of updated data.

### BACKGROUND OF THE INVENTION

1. Field of the Invention

This system and method relates to dataset pricing, valuation, and exchange through users of electronic devices interacting with websites or servers. More specifically, it introduces art for a dataset trading method and system that includes incremental improvement of dataset content, recognition rewards awards bounties and upgrades of levels of access and rights for users who contribute data or modify data, and leveraging of social networks and other linked groups of consumers and producers of data to improve the value and utility of datasets.

2. Description of the Related Art

As datasets are increasingly exchanged and traded over the Internet, users and producers of data in the various forms of databases, data tables, streams of data from RFID tags, data generated by and through messaging services and social networking sites, and data generated by the multitude of electronic devices capable of implementing computer readable code need improved and additional tools to derive value from the data as well as need systems and methods to enable and encourage or offer incentives to exchange and trade data among data creators and consumers. The World Economic Forum has described data developed by individuals through social networks and electronic devices as a “new asset class”. Exchange of data assets through electronic devices capable of implementing computer readable code using hardwired and wireless transmission at the right point in time has value for businesses, organizations, researchers, and ordinary consumers or individuals.

Datasets typically expand incrementally through the addition of columns or rows or the insertion of new or additional data into existing rows or columns within datasets. These rows and columns may house data points, data objects, hyperlinks, and other content capable of being stored within a dataset. These datasets and their rows of data, columns of data, data items, and embedded or attached files or links and other data objects carry structural features, identification features, and characteristics and attributes that can be used to catalog, assign, describe, classify, track, price, establish reward levels or points, set auction price minimums, and provide further options for managing the data as well as ways to associate or link datasets to each other.

Recently, data exchange, collaboration, warehousing, aggregation, and federation have become part of the business analyst's lexicon and businesses individuals and organizations who want to extract value from and for their data are arranging exchanges and trades of datasets generated by or through any of the means for electronic capture and transmission of data. Additionally consortia of researchers, businesses, organizations, agencies, and other producers of data are increasingly exchanging data and aggregating or federating datasets. Further, the advent of Wikis, blogs, and social network sites such as Facebook where participants (users) input currently unstructured data and data objects and offer input or edits or contributions or are enabled to modify, correct, comment upon, or append data already posted into a Wiki, blog, or social network site opens the possibility to leverage both the social networking capabilities and implicit as well as explicit reward systems inherent within these social networks for improvement and upgrading of datasets themselves. There is significant potential social benefit to expanding the use of social network services and Wikis and blogs beyond their current capability to accept and process unstructured contributions, such as reviews, links, and messages, into a capacity to accept and process both structured and unstructured contributions to datasets. There is a need for these exchanges to be enabled through effective systems and methods, and to enable the parties involved in these exchanges or trading activities to set and adjust pricing and fees and to be rewarded psychologically, professionally, and socially. An example of the technology being evolved to increase the granularity of change and modification of datasets is illustrated by a projects such as Accumulo, which offers a way to leverage databases such as Cassandra for a sorted, distributed key/value store is evolving cell-level access labels and a server-side programming mechanism that can modify key/value pairs at various points in the data management process.

Most current data warehousers and federators do not using these methods because of the widespread distribution of legacy enterprise databases. As methods and systems for incremental upgrading of datasets become widely available to the data originator in real time, the dataset owner will assign a dataset to a data federator or aggregator of data on a website or server owned by the federator or aggregator and will no longer retain access to the data. While a new version of the entire dataset may be transferred to the federator or aggregator periodically, the process is less than maximally efficient. Another common process is for a dataset owner to retain the data on their own server internally and connect it to a website or server that provides access to potential purchasers or users who are able to authenticate on the server. Potential users or purchasers will register on a website or server of a dataset owner or federator or aggregator or data warehouse operator to initiate an authentication process within a website or server prior to accessing one or a plurality of datasets on the website or server.

There have been significant improvements to collaboration processes and practices that involve datasets, such as those used by Google Docs and a variety of content management systems that enable changes and updates to data by multiple users, but until the invention described herein, there has not been art that teaches how to lock a dataset for the original owner while a dataset is in the process of being traded to a second owner. Also, there have been efforts to enable exchanges of data and information through social networking sites, but, until the invention described herein, there has not been art to use social and psychological as well as financial incentives to motivate users of social networks to incrementally upgrade and improve datasets. At this point, art as taught by Smith (Ser. No. 12/930,280), teaches a pricing and fee exchange process to transfer data through a handshake or contractual agreement. Dataset users or purchasers may be enabled to participate in various interactions with various Graphical User Interfaces of data management sites, Wiki sites, blogs, and social networking sites. All of these run on servers or websites and may therefore be capable of implementing API's associated with activities involving the one or a plurality of datasets. Sometimes options are available for users of these datasets to append or restructure or reconfigure them in some fashion. Dataset purchasers and users can benefit from options for interaction with datasets and from the ability to engage in data trading and incremental improvement and adjustment of datasets in real time.

Smith (U.S. Pat. No. 7,860,760) introduced art to enable a system and method for enabling the pricing of notifications and server actions triggered by new or updated data items streamed or posted into a dataset or onto a server, but did not address methods and systems to enable pricing or rewards from social networking services. Additional art introduced by Smith (Ser. No. 12/932,797) describes a system and method for tracking and pricing and managing the interaction of a user with a graphical user interface on a website or host server as the user interacts with a dataset or a plurality of datasets. This invention is a Continuation in Part of that patent application by Smith (Ser. No. 12/932,797). Wikis. Blogs, and social network sites such as Linkedin and Facebook offer the opportunity to integrate new methods and systems to expand access to data and the quality of data offered by the many users of social networks. These sites do not currently provide access to systems and methods such as the one introduced in the invention described herein to improve and upgrade datasets within them.

### BRIEF SUMMARY OF THE INVENTION

The system and method of this invention facilitates upgrading, editing, and trading of datasets to enable and ease monetization as datasets are modified and exchanged. In particular, a method and system is provided to enable a first user to register a dataset by entering registration or authentication information into a website, or to use an already active assigned registration or authentication account assigned to the first user through a website or social network application such as Wikipedia or Facebook or Linkedin. Indeed, any server capable of implementing computer readable code can host user registration or authentication information and allow access to information about a dataset associated with the user on the website or server. The information may represent for each dataset respectively, the initial content of the respective dataset which content may be changed by the user through interaction with the respective dataset using functions available through the website or social network application or server to form a unique version of the dataset with attributes characteristics components content and data objects that incrementally improve the utility and value of the dataset.

Additionally, the website or server or social network site may enable transfer of a dataset including all of its changed attributes characteristics components and content from a first user to a second user or a plurality of users, while allowing the first user to continue to use the website and the dataset, but preventing the first user from interacting with the dataset transferred to a second user or a plurality of users. Thus, a sales or trading process is embodied by the invention described herein.

Additionally, the method may be primarily embodied in such a fashion as to enable a first user to access a website and to enable the first user to append additional content through inserting rows or columns or data items or to associate files and hyperlinks or other data objects into at least one dataset associated with the first user on a website or server, and enabling the first user or administrator or coordinator of a website or social networking service to register a second or a plurality of datasets by assigning a unique identifier to associate with the second dataset or each additional dataset respectively, where the unique identifier allows access to the dataset when the user enters the correct identifier concurrent with being actively registered or authenticated on the server or service or website. The method enables iterative customization of one or a plurality of datasets and includes providing an option for a first user to transfer a second or a plurality of datasets to a second user or a plurality of users, where the transfer disables the unique identifier or code assigned to the first user, thus preventing the first user from accessing the dataset consigned to a second user or datasets consigned to a plurality of users, and providing a new unique identifier or code to the second user or plurality of users with access to the second or a plurality of datasets as customized or reconfigured when ownership or access was transferred.

According to another embodiment of the invention, a method is provided for a website or server to enable a user to access functions and capacities of a website, (including websites for social network applications such as Facebook or Linkedin, or a Wiki site such as Wikipedia) or server and to post one or a plurality of datasets onto the website or server by the website or server accepting registration information for the one or a plurality of datasets to be posted. Each dataset is linked to unique registration information associated with each user and with rights or levels of access available to each user to enable the user to access configuration information about each dataset, including initial attributes characteristics components and content possessed by the dataset, and allowing the user to reconfigure the dataset by changing column or row or data item or file characteristics attributes or hyperlinks or data objects included in the dataset through interaction with the Graphical User Interface on the website or server; and providing an option for using one or a plurality of functions on the website or server to enable the user to price, advertise or announce (through a social network or messaging system), sell, auction off, or trade a version of the specified dataset as reconfigured to another user.

According to yet another embodiment of the invention, a method is provided to accept registration information for a dataset to be accessed on a website or server, the registration information identifying the dataset to be accessed; posting information about each of a plurality of different attributes characteristics components or content associated with the dataset to be accessed and/or one or a plurality of values or prices to be associated with one or a plurality of rows, one or a plurality of columns, one or a plurality of data items, one or a plurality of embedded or attached files, or one or a plurality of data objects or other attributes characteristics components or contents; thus enabling a user to allocate one or a plurality of values or prices or minimum auction values, or bounties or rewards among and between the different attributes characteristics components contents or data objects, wherein each of the different attributes characteristics components or contents or data objects are allocated values or prices or bounties or rewards respectively; and allowing the user to interact with the dataset on the website through selection of one or a plurality of attributes, characteristics. components, contents, or data objects.

According to yet another embodiment of the invention, a method is provided to push a registration request from a website or server to the server or website of a potential data contributor, the registration information keyed to the dataset to be upgraded improved or changed; and capable of automating the posting of uploaded information about each of a plurality of different attributes characteristics components contents or data objects associated with the dataset to be accessed, and/or one or a plurality of values or prices or bounties or rewards to be paid to the contributor who uploads one or a plurality of rows, one or a plurality of columns, one or a plurality of data items, one or a plurality of embedded or attached files, or one or a plurality of data objects or other components or contents; thus enabling a remote user to upload and be compensated for changes to a dataset without needing to view or have access to the dataset. This special case of registration can restrict visibility into the dataset, yet allow a user to make a contribution to the dataset of updated or additional attributes characteristics components or contents or data objects.

In an embodiment of the invention that uses social networking sites or Wiki applications (i.e. Facebook, Linkedin, Wikipedia), registration authentication and access is regulated through the procedures provided by the social networking site or application. Within a social networking application, the user selects the links provided to the user by the social networking application to join a “group” or note an “interest” or to select a “Like” or “recommend” option or other linking or association method provided to users of social networking applications with user profile tags and links such that the user identifies a category or class of datasets or a single dataset as described in the invention herein. Additionally, the user of the social networking site may select one or a plurality of “friends” to associate with the one or a plurality of datasets.

For social networking applications, the reward system is not only financial, but related to social and psychological motivators. The financial motivators may be part and parcel of the system for compensation for the upgrading and improvement of a dataset, but additional compensations and incentives may be included, such as an incremental increase in the status of the user, such that the user can rise through levels through the accumulation of points rather than fees. For example, one of many possible names for contribution points could be “Data Star” points and the number of these a user accumulates through making contributions of datasets or making incremental changes or improvements to datasets can be posted onto their social network “profile.” They can also rise in levels based upon the volume and quality assessment of their contribution made by other users of the social network or by designated arbiters of the value of contributions assigned by the social network or Wiki or blog to administer or evaluate contributions. These increases in level can carry labels that reflect increasing expertise and status. Further the increment in level may also entitle the user to higher level access to view or interact with the datasets themselves or to utilize functions and capabilities of the social networking site. Examples might include a notification when other users have made a change to a dataset or the right to use a distribution function to forward the revised dataset to a preferred list of “friends.”

Another reward mechanism in this type of embodiment is to offer financial prizes for the best or most valuable data contribution within a unit of time. Yet another reward or bounty or incentive mechanism in this type of embodiment is to enable members of the social network site to assign points to a dataset according to popularity of the topic or the contribution within the dataset (i.e. best organic wine released this week), importance of the data (i.e. changes in the flight plans of persons on a terrorist “watch list”), urgency of the data (i.e. current locations of a tornado) and other criteria and to announce the user (i.e. “Data Star”) who contributed the data to the dataset or perform an automatic upgrade of the status level of the contributing user or give a financial reward or bounty to the contributing user. Additionally, those users who contribute frequently or effectively may be provided one or a plurality of “medal” or “badge” logos to post on their page.

In some embodiments of the invention described herein, access to datasets may be tiered into levels of access or rights to use or functions or “bots” or utilities implemented through computer readable code on websites or servers or through social network sites with fees and prices adjusted upward or downward according to the level of access for the user of the dataset. An example of an embodiment using a tiered approach is one that would enable a retailer to receive a pushed notifications in real time of changes to a dataset related to products or services they offer, to enable a shopper to view the set of changes in the availability of a product or service over the last few days by logging onto the site or server housing the same dataset, and to enable a member of a social network to view a cumulative, but unstructured or less structured list or posting of changes to the same dataset respectively. Thus retailers, researchers, service providers, or manufacturers would be able to have an advantage in awareness of market or data changes before others with an interest in the same data get access to it. The assignment of tiers of access to pushed or pulled data from a dataset or a plurality of associated datasets also enables the owner or administrator or manager of the electronic device or website or server or social networking application or Wiki to collect fees in accordance with the tier of access purchased from the electronic device or website or server or social network service provider or Wiki. Thus the method and process enables a market for access to data to be managed and implemented when the contributor of the data is not in a direct relationship with the purchaser of the data. The owner or administrator of the electronic device or website or server or social network application or Wiki can operate in the same fashion as a middleman or distributor where the data is acquired from the data creator or contributor, then sold at a markup to the data purchaser as repackaged or reconfigured or with differing levels of service or timeliness.

The summary above is intended to provide a basic outline of aspects of the system and method discussed herein. This summary is not comprehensive and does not identify all critical elements or comprehensively delineate the scope of the system and method of the invention. The drawings attached also are not intended to be inclusive of all possible embodiments of the invention, but to illustrate a few of the various ways in which the principles of the invention may be employed. The invention is intended to include all embodiments based upon these principles. Other advantages and features of the invention may become apparent from the following detailed description of the invention considered in conjunction with the drawings.

### BRIEF DESCRIPTION OF THE DRAWINGS

FIG. 1 diagrams components of the invention and linked operations for a dataset evolution system that facilitates allocating characteristics components and contents to a dataset and developing those attributes characteristics components and contents and/or new attributes characteristics components or contents to enhance utility of a dataset for research or analysis and enable trading, pricing, and fees.

FIG. 2 is a block diagram of the process for dataset registration, posting and fee exchange.

FIG. 3 is a block diagram illustrating the relationships and processes for changes to datasets and pricing and awards.

FIG. 4 is a block diagram of the dataset attribute, component and content adjustment method and system for dataset evolution, posting and exchange and rewarding of contributors.

FIG. 5 is a diagram of event sequence for inputting changes to datasets and transferring ownership

FIG. 6 is a block diagram illustrating a top level schematic of the utilities, datasets, devices, and pricing and reward systems of the dataset evolution and posting and exchange system of FIG. 2 to expand one or many possible embodiments for a social networking and Wiki model for interacting with datasets.

### DETAILED DESCRIPTION OF THE INVENTION

The system and method described in further detail below relates to an incremental dataset development and exchange process through which a user can, through invoking or using authentication rights or codes associated with an electronic device capable of implementing computer readable code, open review and modify one or a plurality of datasets through a web enabled interface linked to a website or server (as represented on a electronic device capable of implementing computer readable code and able to display a Graphical User Interface), and obtain one or a plurality of datasets or versions of datasets associated with one or a plurality of users. The datasets can be comprised of various structures and attributes with specific classifications. It is intended herein that the term “characteristics” includes all features and associations with a dataset as a whole and the term “attributes” include all features and associations with rows or columns or data items or embedded or attached files or data objects associated with a dataset; such as data masks, data types, data values, data and text strings, digital characters and symbols, and including images and other files readable by devices that can implement computer readable code. It is further intended herein that the term “components” include all parts of a dataset such as the actual rows or columns or formulae or functions that may be inserted, appended, deleted, modified, or otherwise adjusted by a user drawing upon functions available to the website or the server to cut or paste or post or perform other actions that are common to interaction with datasets and can be initiated by a user or through an automated or user initiated process to implement computer readable code or through invoking functions or utilities or “bots” that may be implemented through computer readable code. It is further intended herein that the term “contents” include all data objects, attached files, hyperlinks and data items associated with an attribute or a component associated with a dataset.

Types of devices that can house or store data or serve as conduits for transmission of datasets described in the invention herein are smart phones, servers or computers, laptop computers, pad computing devices, RFID readers and writers, electronic UPC or ePC tags, point of sale devices, credit card readers, ATM or bank transaction machines, drivers within electronic appliances, and other wired and wireless devices capable of implementing computer readable code.

In a typical embodiment, datasets are initially consigned or sold to a data vendor or retailer or federator or aggregator in an initial state or status having a set of characteristics or attributes components and content to use as a starting point accessible to the user who consigned the dataset and who is able to authenticate upon the site. Other potential data traders are, data warehousers, data producers, data brokers, automated message services, manual message services, social networks, and Wikis.

Each dataset may be revised, appended to, and reconfigured from its initial state into different configurations and iterations. This can be accomplished in part by any one user or by a plurality of users who are authorized through authentication and registration rights within the site or upon the server to append or delete or adjust the characteristics of the dataset or to adjust attributes of rows or columns or individual data items or associated files or data objects. Each user may have a unique code associated with the current version of a dataset. Each user may consign their dataset to another user or a federator, aggregator, warehouser, social network site, Wiki or blog, or they may choose not to consign their dataset, but retain access and ownership on their own server. Automated additions or subtractions or reconfigurations of the dataset can also be implemented through computer readable code or by one or a plurality of users implementing functions on or through the website or through any electronic device capable of implementing computer readable code acting in the capacity of a server, using codes associated with the datasets and authentication available through registration of one or a plurality of devices. Further, automated additions to or subtractions from or reconfigurations of the dataset may be implemented through functions driven by electronic devices that connect and interact with the website or server as well as through functions within the website or server to enable it to include or insert or link to additional dataset attributes from associated datasets, all of which may adjust the values or prices or auction minimum values, bounties or rewards for data fields, rows, columns, embedded files or data objects drawn from the dataset, and all of which can accumulate and be subjected to calculation to generate a value or price or minimum auction value, or bounty or reward for any portion or single component of the dataset or the dataset as a whole. The adjusted rules and functions and values or prices or bounties or rewards for the items, rows, columns, embedded files and data objects can then be applied to develop other datasets with content or attributes that can then be accepted or reconfigured to unique requirements of the user or a plurality of users who are able to authenticate upon the website or server and access the one or a plurality of datasets using codes assigned to them. In some instances, such as open source datasets, assignment of a user code may not be required.

Datasets are available in different formats and structures. Examples of different types of datasets include Comma Separated Values, variants of extended markup languages such as XML or HTML, spreadsheets such as Microsoft Excel, and enterprise databases such as Oracle, SAS, SAP and so forth. Datasets may be converted into alternate formats for federation or aggregation. Processes, functions, methods, and actions that involve the insertion or deletion of columns, rows, data items, linked or embedded files, and data objects along with attributes and contents of the rows, columns, data items, embedded files and data objects are the province of this invention. Any formats or structures for datasets and data items are subject to and included within the scope of this invention, provided the dataset is capable of being processed through computer readable code running on an electronic device.

Datasets with similar characteristics may be grouped into many different classes dependent upon user decisions and classification schemata. Ownership of a dataset assigned to any one class will unlock content available to that class. As additional datasets are assigned to different classes, these may be made available and viewable to one or a plurality of users with rights to access that class of dataset. Thus, additional datasets may become accessible to the user as the user engages with more datasets of different classes. In a similar manner, dataset configuration can also be limited by or based upon the type of the dataset. For example, an SPSSS dataset cannot be accessed as if it were an XML dataset. However, some classes of datasets can be linked or associated through the website or server to allow for extraction of data items from one class to another through copy and paste operations or other functions.

As a dataset is configured, expanded, appended to, and developed to enable it to include more columns, rows, data items with their associated attributes and contents, and to associate hyperlinks and files and additional data objects, the overall value of the dataset will increase. To reiterate, for purposes of the invention described herein, the term “component” will refer to any objects or structural components that comprise a dataset, such as rows, columns, cells, data items, hyperlinks, files, data objects, or other features or contents. A dataset will incrementally increase or decrease its value for trading or exchange or fees to be charged to other users of the dataset dependent upon the content it houses. Hence, this process enables monetization of a dataset as well as a basis for setting bounties or rewards in social networking sites. Further this process enables the assignment of differing levels of access to functions on a site or server and to additional datasets or classes of datasets in accordance with the volume and quality of the user's contribution to one or a plurality of datasets.

The combination of the dataset and its associated components such as the columns rows data items hyperlinks files and other data objects within the dataset are used to calculate its value or price or minimum auction value, or bounty or reward value. As an example, a first user may develop a dataset of violinists. The first user can make the violinist dataset available for exchange or trade or sale. A second user who is building up a musician dataset may want to acquire a dataset of violinists as a subset of the musician dataset. Through a direct mechanism for buying, selling, trading, auctioning, or otherwise exchanging datasets and their components between users, the second user can acquire the violinist dataset from the first user.

An embodiment of the invention enables secure transactions through use of the code assigned to the dataset, and the code may include class identification and other variables to use to assign and control access to users with the correct credentials and authorizations. This code assignment further enables a dataset to be tracked through a sale or transfer process. For example, when a dataset is made available for exchange, sale, auction, trade, or transfer, the dataset is in effect “locked” to prevent a user from changing the dataset during the period it is for sale, but the code will enable the owner of the dataset to retain the option to remove the dataset from sale, auction, or trade. When a transfer resulting from a sale or trade is confirmed, the current code assigned to the dataset is disabled or deleted and a new code is generated and assigned to the dataset and provided to the new user or owner of the dataset. The new user or owner can then add the dataset to the set or group of datasets associated with that user's account and manage it and improve it as desired.

The set of utilities in code readable by electronic devices and capable of being implemented across devices and websites or within social networking sites to enable the method and system of the invention described herein include the following; a user registration and authentication utility, a dataset registration utility, a social network linking utility, a dataset announcement or advertising utility, a dataset analysis utility, a dataset locking utility, a dataset transfer utility, a dataset trading utility, a blind data or dataset contribution utility, a dataset updating utility, a component selection utility, a dataset editing and configuration utility, a dataset auction value assignment and processing utility, and a dataset pricing reward or bounty utility. Additional utilities may be developed to manage the method and system of the invention. These utilities may not all be implemented within each embodiment and the order or sequence of their implementation may change according to the needs and capabilities of the websites, servers, or social network applications they will interact with. Their function and operation should be evident, but where they are not evident, they are described in the more detailed descriptions.

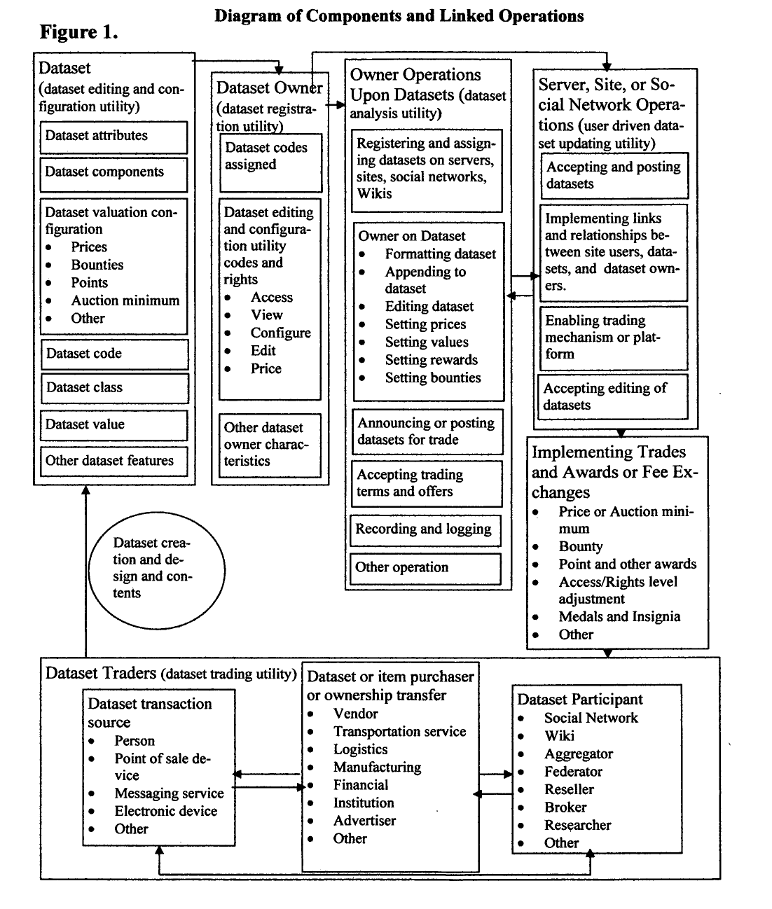

The subject application will now be described in further detail with reference to FIGS. 1-5.

FIG. 1 shows a general block diagram of the iterative dataset development and exchange system. The system includes a set of utilities enabled through computer readable code that can be implemented upon an electronic device, such as a dataset editing and configuration utility to track characteristics, attributes, content, components, classes, codes and values that is linked to the dataset owners rights. The dataset registration utility that registers the dataset through a communication network via a code. The code can be unique to the particular dataset and can provide various rights to act upon the dataset associated with the dataset and the user. For example, the user may purchase the dataset and/or another service related to the dataset (e.g., automatic updates, notifications of changes in linked data objects). Upon such purchase, the code is provided to the user. The dataset registration utility receives and processes the code in order to give the user control of the dataset within the website or server. Following registration, a dataset editing and configuration utility can enable changes to the rows, columns, data items, and data objects within the dataset as well as access to views, configuration rights, editing rights, and pricing or trading rights.

Changes that can be enabled are based on the type and/or class and characteristics of the dataset. For example, if the dataset is for violinists, then the changes may include changes to the columns for concert dates, compositions played, violin brand used, music conservatories attended, contest prizes or awards, and instructors or teachers. Initially, the dataset may contain a baseline set of columns and rows and data objects with preset values (e.g., compositions=2, conservatory=2). In some cases the value of an initial dataset component may be relatively low, leaving potential for the dataset to improve through incremental additions. For instance, the component value can be based on a 10-point scale, where 0 indicates no concerts and 10 indicates more than 100 concerts. Initially, for example, the attributes can be allocated in a preset or standard manner so that each component is given a value of 2 as shown above. This standard value can differ according to the type of dataset as well as its class. That is, values may be based on a different value scale depending on the type of dataset and class of dataset. Alternatively, the dataset can be more specialized, such as a classical violinist dataset.

The system also includes a dataset analysis utility that extracts and posts the dataset's components to determine the types of users who might want to operate upon it and to determine what kind of changes should be tracked within it. Associated with the data analysis utility are features to enable an owner to format a dataset, append to a dataset, edit a dataset, set prices for a dataset, set minimum auction bids or values, set values for a dataset, set rewards for a dataset, set bounties for a dataset or even set auction parameters for a dataset. Thereafter, the dataset can be manipulated by a user driven dataset updating utility, which increases or decreases the value of the dataset, or the dataset can updated through an automated updating utility by electronic devices that generate data items such as UPS locations. When the dataset is undergoing updating, it is not subjected to the dataset editing and configuration utility. A user may be charged a fee to input, view, or download the updated dataset. Fees may vary depending on the class and content of the dataset. Also included is a dataset trading utility. The dataset trading utility locks the unique code associated with the dataset and its characteristics (e.g., database format, creation date, originating server etc.) so the current owner of the dataset can no longer change or otherwise alter the dataset during the “sale” time period. To complete a trade and transfer the dataset to a new owner, the dataset trading utility also generates and/or assigns new unique codes for the dataset and its characteristics and attributes. The original owner no longer controls the dataset. Also available to be implemented are other utilities that can further enable data improvement and dataset trading. Relationships of the dataset and owner and the trading and transfers of the data to the next owner and the devices and persons that may be part of the process are also managed through the dataset trading utility,

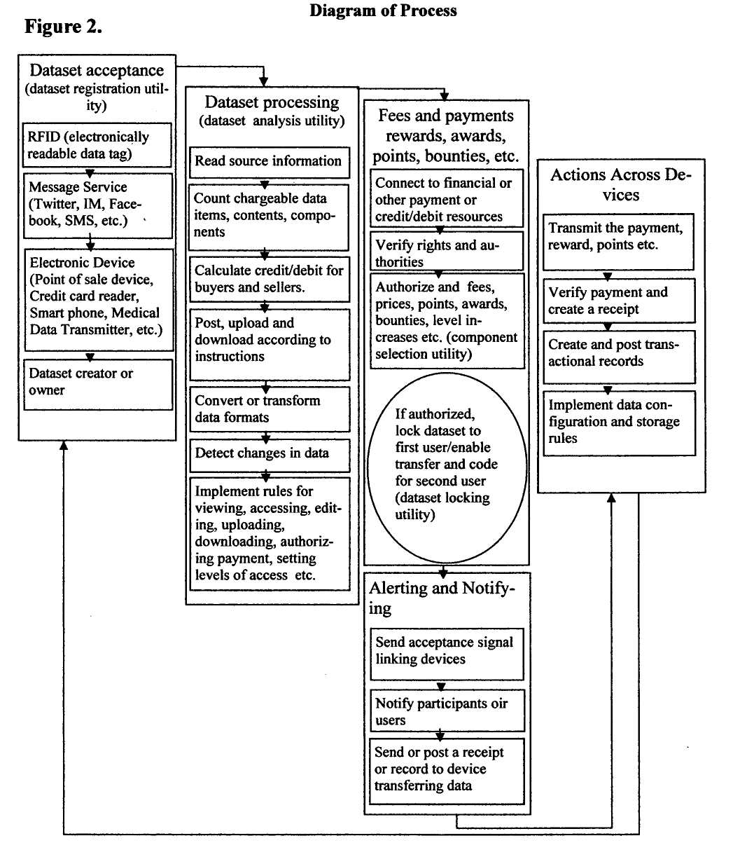

FIG. 2 presents a diagram of a dataset improvement and exchange process that facilitates allocating components to a dataset and moving the dataset among devices and owners or users, as well as diagrams how the process unfolds to update the dataset with additional components or data objects in order to increase the value of the dataset. Capabilities of features of the dataset registration utility and the data analysis utility are also illustrated. The system is similar to the dataset improvement system discussed in FIG. 1, but includes a dataset locking utility. The dataset locking utility locks the unique code associated with the dataset and its characteristics (e.g., database format, creation date, originating server etc.) so the current owner of the dataset can no longer change or otherwise alter the dataset during the “sale” time period. To complete a trade and transfer the dataset to a new owner, the dataset locking utility also generates and/or assigns new unique codes for the dataset and its characteristics and attributes. The original owner no longer controls the dataset. Additionally illustrated in FIG. 2 is the linking across devices of actions related to datasets as alerts and notifications are implemented by changes in ownership.

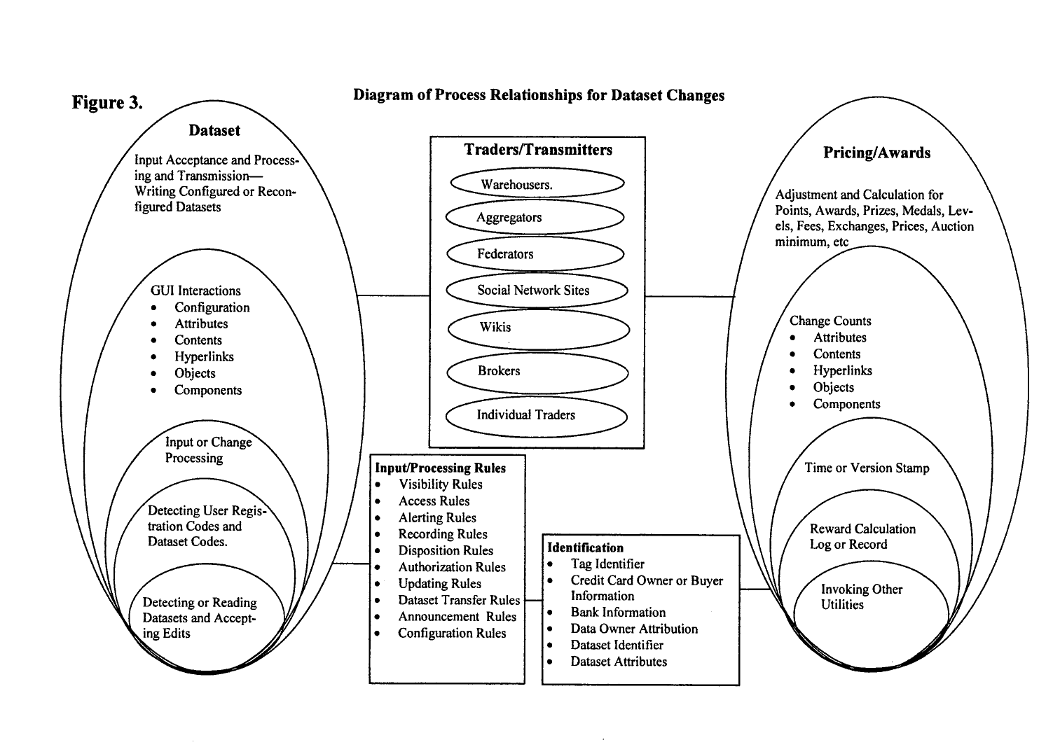

FIG. 3 diagrams embedded sets of processes and relationships of the invention to include identification and rules. Three major categories are illustrated, beginning with the datasets and embedded processes related to them, then moving to the alternative traders and transmitters of the datasets and the actions upon them related to pricing and awards and the embedded operations that can be managed within a pricing and award structure. Rules related to identification and processing that link pricing and datasets are also shown.

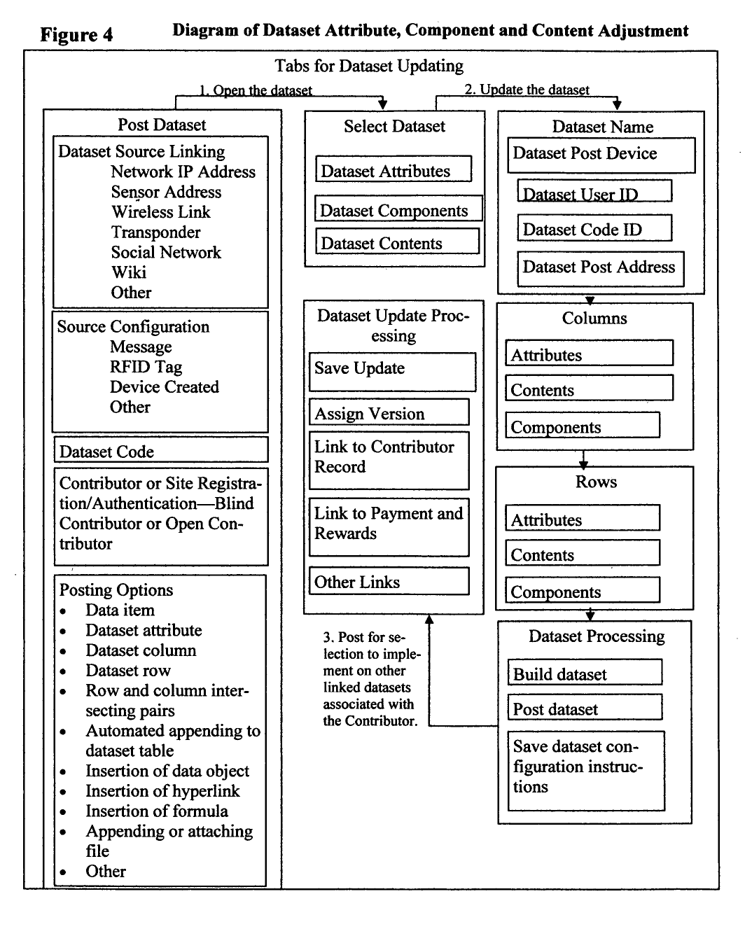

FIG. 4 illustrates how the embedded processes of FIG. 3 get operationalized within datasets with the purpose of establishing their characteristics and attributes and components and contents and linkages. The sources of the originators or transfer points or devices or services for the dataset, the current configurations and structure and characteristics and attributes of the sourced dataset, the dataset registration code, the inclusion of registration options to enable blind contributions from a user of the system who does not have a view or options to purchase or trade a dataset, as well registration options for users who are provided views and data trading options, and the assignment of posting choices and options are illustrated under the “post dataset” heading. When the dataset is opened, the selection options and specifications for the dataset are also opened and the dataset can then be configured and characteristics and attributes of it designated and assigned before being saved, with the saved version being available for other processing or assignment to other users.

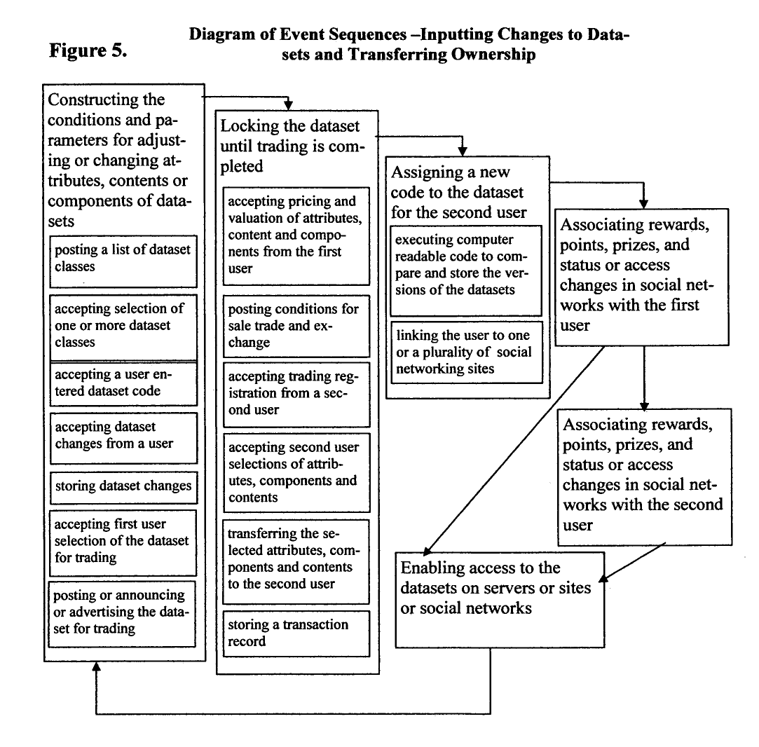

FIG. 5. diagrams the sets of associated actions for the primary operations within datasets through user interaction with the GUI. Illustrated is the flow of the process from construction of the dataset to locking the dataset as it is prepared for transfer to a second user, to assigning ownership of the dataset to the second user, and to associating rewards for both the first and the second user resulting from the ownership transfer. The dataset is then made available to designated users for additions or reconstruction or reconfiguration for the process to continue iteratively.

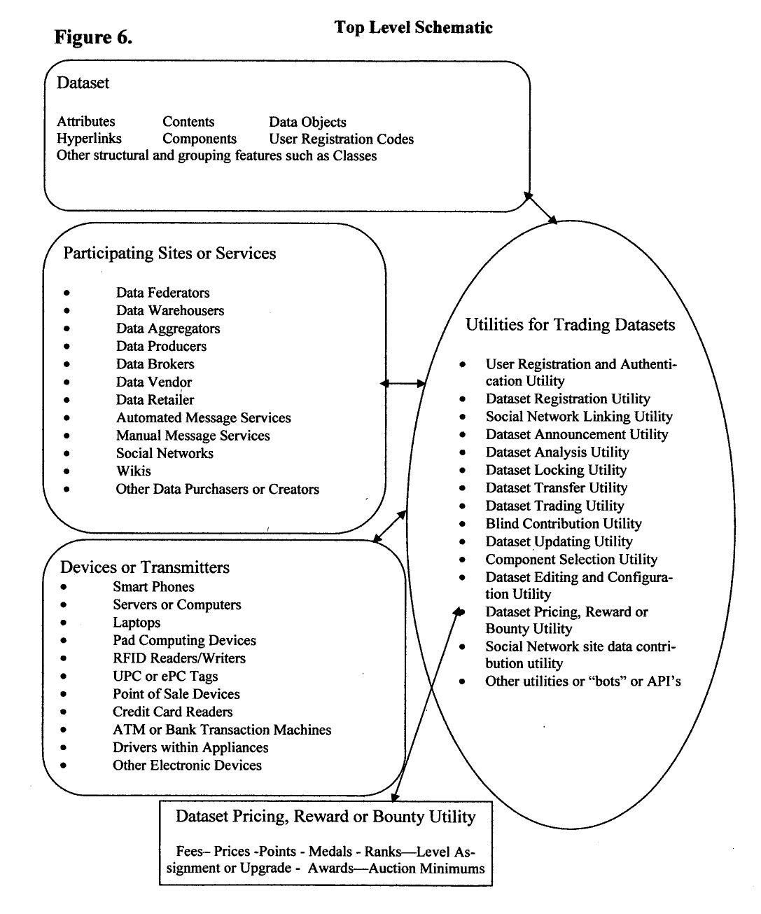

FIG. 6. diagrams the top level of components of the invention showing how FIG. 1 through FIG. 5 are tied together in a simple schematic that groups the utilities of computer readable code and shows how they are linked to datasets, participating sites, devices or transmitters, and to the pricing and reward process that is a central aspect of the invention described herein.

To expand further on the use and implementation of utilities; when a dataset is made available for sale, auction, trade, or exchange, the initial value of the dataset is dependent upon its characteristics, attributes, components, content, data objects, classification, and type. For instance, a certain class of dataset can be rated at a higher value based on current demand for the dataset based on popularity of the data within it. A dataset trading utility effectively blocks access to the dataset by the user (or locks the dataset) to prevent the current user from modifying it while it is available for sale or exchange. If the exchange is made, for example, the dataset trading utility can disable or delete the code assigned to the dataset and generate and/or assign a new code to the dataset. The new owner receives the new code and registers the dataset via the new code in order to access and exclusively control it. If the exchange is not made and the user decides to retain ownership of the dataset, the data trading utility can unblock access to the dataset. More specifically, the dataset trading utility includes a code verification component to verify current ownership of the code and locks the dataset associated with it.

If the dataset is transferred to another user, a dataset transfer utility disables or deletes the lock code and generates and/or assigns a new code for the dataset. The dataset trading utility also comprises a dataset analysis utility that can examine the dataset for its particular characteristics, attributes, components, content, data objects, class, current status, and its incremental history of changes. These changes can include additions, deletions, changes, operations performed upon the dataset, and actions initiated upon the server housing the dataset due to changes in the dataset. After this dataset analysis has been posted, a valuation utility can determine a value for the dataset using the dataset history as well as comparative histories of datasets of similar popularity, or in consideration of its class, type, characteristics, attributes, components, content and data objects. If the current status of the dataset indicates that the trend for usage or activity is decreasing, then the overall value can decrease by a variable amount depending on the degree of decrease.

A processing fee can be charged to the user for each dataset posted via the trading component (e.g., a fixed fee per transaction or percentage of final sale price). Alternatively or in addition, the dataset trading utility can evaluate or calculate the value of a dataset requiring the dataset to be posted for sale, auction, or trade. A separate fee can be charged for this service. Users can also employ a fee-based dataset announcement utility in order to create more interest for their datasets and/or for the users who are using or accessing the datasets. As a result, other users may target certain users who consistently offer good datasets for sale, auction, or trade.

In some cases, a user may wish to sell a portfolio of all owned or assigned datasets. For these instances, the entire account can be evaluated based on the valuation of each dataset if sold individually or in groups of at least two. This is because some datasets may have a higher value when paired with a complimentary dataset than when considered alone. If desired, the user can indicate how datasets are to be grouped when offered for sale or how they must be sold. FIG. 4 illustrates a block diagram of the method and system for a component adjustment aspect of the dataset development system of FIG. 1 that allows for updating the dataset with additional components based on existing components of the dataset. Before updating, a dataset analysis utility can evaluate the current status of the dataset to determine a current list of its components, which may include any or all of the rows, columns, data objects, data items, links, and associated files, as well as the dataset's class and/or type. Based on the existing components, a component selection utility can select one or more components from a component table to calculate a price for these components. However, the component selection utility can be programmed so that it is not permitted to select components that would exceed a threshold amount set by the user.

A blind contribution utility which pushes registration information to a potential contributor of components or content to a server or website and enables that server or website to upload components or content to the dataset is also associated with FIG. 4. A blind contribution utility can be useful for accepting contributions to datasets with components or content that need to remain confidential to retain a competitive advantage or for security reasons. The use of levels of access to datasets includes this special case of blind contributions as one category or level. Other uses of levels are associated with reward and status systems within social networks or with hierarchies of professional certifications or training or other considerations where layering access for viewing, editing, and exchanging can be advantageous to increasing quality or managing risks.

Users are not required to possess programming knowledge to create a more valuable dataset. Updating options for a dataset are restricted by its classification. For example, a violinist dataset cannot be updated with components that are incompatible with the characteristics, classification, and type of dataset. Datasets can also decrease in value if some of their components are removed or lose value in the marketplace.

The top level schematic in FIG. 6 illustrates the relationships of utilities, devices, datasets, and rewards including the social networking aspect of the data trading system and method. It illustrates how using a social network linking utility may enable a user to associate a dataset with a user's profile on a social networking site, thus enabling the user to leverage network membership to improve the quality and volume of data within the user's dataset through opening the dataset to contributions by members of the network; to elect to participate in purchases or trades of datasets with other network members; to make contributions to datasets owned or managed by other users of a social network; to accept and integrate levels or layers of rights or links to functions or utilities accessible to users of the invention described herein within the social networking site; and to initiate or link to functions or utilities accessible to users of the invention herein external to the social networking site. Users of social networking, Wiki or blog, or other sites with open access to networks of members and with levels and layers of integration with rights or associations with groups or interests or subsets of “friends” may draw upon code that can be implemented through an electronic device to designate a level of access or service associated with a dataset and correlated to contributions to that dataset to transfer an upgrade or downgrade of level of access to functions of the social networking or Wiki or blog site, or to upload or download medals or logos or bounties or points or funds in accordance with the social network reward system enabled through the social networking or Wiki site.

The dataset development system as discussed through FIGS. 1-6 can also catalog a user's collection of datasets in order to maintain a history of datasets that have been acquired, and/or sold by the user over time. For each dataset, activity logs, characteristics, attributes, content, and data objects can be stored and subsequently retrieved and viewed. If the dataset is a member of a class of datasets, class activity logs can also be stored and viewed. As a result, each user can build a history of data activities that can be securely viewed and shared with others. The history can also include any pertinent class or characteristics for each dataset. Datasets can be combined and characteristics, attributes, content, and data objects carried into the combined dataset. When a dataset is sold to another user, the dataset class can also be passed along with it so each subsequent owner can track the dataset trough its iterations and relationship to other datasets.

What has been described above includes examples of the system and/or method for the patent described herein. It is not possible to describe every combination of processes or utilities or configurations for purposes of describing the system and/or method of the patent described herein, but one of ordinary skill in the art may recognize that many further combinations and permutations of the system and/or method are possible. Accordingly, the system and/or method of the patent described herein is intended to include alterations, modifications, and variations that fall within the spirit and scope of the appended claims.

Furthermore, to the extent that the term “includes” is used in the detailed description or claims, the term is intended to be a synonym of the term “comprising” as “comprising” is interpreted when employed as a transitional word in a claim. As used herein, the terms “utility” is intended to refer to computer readable code that may be embodied in hardware or electronic devices, or a combination of hardware and compilations of computer readable code.

1. A method and system for using an electronic device to accept and store registration information to register a first user and one or a plurality of datasets associated with a first user to enable;
using by a first user an electronic device capable of implementing computer readable code to provide access to information indicative of one or a plurality of datasets on a website or server based on said registration information, which information represents said one or a plurality of datasets, said one or a plurality of datasets having plural initial characteristics attributes content and data objects based on said registration information, each of said initial attributes characteristics content and data objects able to be changed by the first user through interaction with the one or a plurality of datasets on the website or server to form a unique version of the one or a plurality of datasets that have one or a plurality of attributes characteristics content and data objects that differ from said initial attributes characteristics content and data objects;
assigning a class and type to the one or a plurality of datasets to be retained in a table or list which class may indicate whether a server or website or social network site or Wiki or blog is to restrict access to different levels or types or classes of users based upon the registration information provided by the user;
calculating an estimated value or price for the one or a plurality of datasets based upon previous completed transfers of similar datasets with said one or a plurality of different attributes characteristics content and data objects and a projected popularity of the one or a plurality of datasets in consideration of said one or a plurality of attributes characteristics content and data objects and a class and type of the dataset;
providing the estimated market value, price, auction minimum, social network points, rewards or bounty amount of the one or a plurality of datasets to the first user;
using said website or server, transferring the unique version of the one or a plurality of datasets including one or a plurality of different attributes characteristics content and data objects, from the first user to a second user according to the estimated value or price or auction minimum or social network points or rewards, or bounty amount of the one or a plurality of datasets and the level of access granted to the user;
using said website or server or social network site or Wiki or blog to transfer the unique version of the one or a plurality of datasets including one or a plurality of different attributes characteristics content and data objects of the one or a plurality of datasets from the first user to a second user according to the level of access assigned to the first user and the second user;
and subsequent to transferring the one or a plurality of datasets, granting the first user continued access to said website or server or social network site or Wiki or blog, but preventing said first user from controlling said one or a plurality of datasets after said transferring to said second user.

2. A method and system as in claim 1, wherein said transfer includes listing the one or a plurality of datasets for sale, and responsive to said listing, using the website or server or social network site or Wiki or blog for preventing access to the one or a plurality of datasets by the first user.

3. A method and system as in claim 1, wherein said transfer includes listing the one or a plurality of datasets for sale, and responsive to said listing, preventing changes to the one or a plurality of datasets by the first user;
storing a record of the one or a plurality of datasets listed for sale by the first user including fees and reward points or auction minimums;
storing a record of the dates of the one or a plurality of datasets are sold or transferred;
storing a record of the device, social network, server, website, or Wiki or blog of the originating dataset or plurality of datasets;
storing a record of the device, social network, server, website, or Wiki or blog of the recipient or receiver of the dataset or plurality of datasets;
implementing computer readable code to calculate and adjust the fees and reward points or auction minimums for datasets in the same class as the one or a plurality of datasets sold or transferred;
implementing computer readable code to calculate and adjust the values of the attributes characteristics content and data objects of the one or a plurality of datasets associated with the class of the one or a plurality of datasets sold or transferred.

4. A method and system using an electronic device capable of implementing computer readable code to register a dataset associated with a first user, said registration including a first unique code that is received by said electronic device, and entered into said electronic device, and, in response to being entered, automatically providing access to the first user to the dataset associated with the registration information;
based on said registration information, providing access to information indicative of the dataset on a website or server associated with an electronic device capable of implementing computer readable code, which information represents said dataset, said dataset having plural initial attributes characteristics content and data objects based on said information, each of said initial attributes characteristics content and data objects able to be changed by the first user according to the level of access or rights associated with the level indicated through the registration through interaction with the dataset on the website or server to form a unique version of the dataset with attributes characteristics content and data objects different than said initial attributes characteristics content and data objects;
based on said registration information, assigning a level of access to view, edit, and post additional content or data objects;
calculating an estimated market value, price, auction minimum, points, reward, or bounty value for the dataset based upon previous completed transfers of similar datasets with said different attributes characteristics content and data objects and a projected popularity of the dataset in consideration of said different attributes characteristics content and data objects of the dataset;
providing the estimated market value, price, auction minimum value, points, reward, or bounty value of the dataset to the first user;
and using said electronic device capable of implementing computer readable code to transfer the dataset including all of its changed attributes characteristics content and data objects from the first user to a second user according to its estimated market value, price, points, reward, auction minimum value, or bounty value and continuing to grant the first user access to said website or server, but preventing said first user from controlling said dataset after said transferring, and deactivating the first unique code after the dataset is transferred to said second user, and creating and providing a second unique code to the second user, where the second unique code is associated with an initial level of access editing and viewing rights according to the dataset class, where the second unique code is subsequently received from said second user and used to register and associate the dataset with the second user, and wherein the first unique code is no longer usable to be received to register the dataset after receiving the second unique code from the second user.

5. A method and system as in claim 4, wherein said interaction with said dataset comprises appending data to increase the cumulative value of the dataset and its attributes characteristics content components and data objects.

6. A method and system as in claim 4, further comprising registering one or a plurality of auxiliary data sources that are associated with the dataset, wherein said transferring comprises automatically transferring both the dataset and the said one or a plurality of auxiliary data sources.

7. A method and system as in claim 4, further comprising requiring at least one user to pay a fee or to assign points, rewards, bounty values, tokens, or awards for said transferring.

8. A method and system comprising: using an electronic device capable of implementing computer readable code for accepting interaction or registration from a first user to access a website or server and to interact with at least a first dataset on said website or server;
subsequent to said accepting of interaction or registration from the first user, using an electronic device capable of implementing computer readable code for registering a second dataset by said first user on said website or server by receiving entry of a unique code that is associated with the second dataset and is entered into the electronic device capable of implementing computer readable code, where the unique code as entered is uniquely identified with the second dataset, and where use of the unique code when entered causes information indicative of the second dataset to be obtained from one or a plurality of tables of attributes characteristics content and data objects associated with the second dataset during registration, and grants the first user access to a portion of the website or server for interacting with said second dataset, wherein said interacting customizes said second dataset by assigning to the second dataset one or a plurality of unique attributes characteristics content and data objects;
calculating an estimated market value for the second dataset based upon previous completed transfers of similar datasets with said customized attributes characteristics content and data objects to include a projected popularity of the second dataset in consideration of said unique attributes characteristics content and data objects, including a class and type assigned to the second dataset;
providing the estimated market value or price or minimum auction bid or reward or bounty value of the second dataset to the first user; and subsequent to said grant of access to the portion of the website or server for interacting with the second dataset, transferring the second dataset from the first user to a second user according to its estimated market price or auction value or reward or bounty value, where said transfer comprises deactivating the unique code to prevent using the unique code to access the second dataset by entering the unique code, providing a new unique code to the second user which when said new unique code is entered into the electronic device capable of implementing computer readable code, grants the second user access to the second dataset as customized by the first user on the website or server or social network site or Wiki or blog, and where said new unique code is received by said electronic device capable of implementing computer readable code for registering said second dataset on said website or server, and granting the first user continued access to said first dataset on said website or server or social network site or Wiki or blog.

9. A method and system as in claim 8, further comprising charging a fee or number of points or reward or bounty value for said transferring.

10. A method and system as in claim 8, wherein said transferring comprises listing the dataset for sale, and responsive to said listing, preventing the first user from interacting with the second dataset.

11. A method and system as in claim 8, further comprising maintaining a master table of attributes characteristics content and data objects of one or a plurality of datasets on the website or server or social network site or Wiki or blog, said master table including other values based on previous completed transfers of a similar one or a plurality of datasets which are customized in similar ways to said second dataset.

12. A method and system as in claim 8, wherein said interacting comprises appending data to the dataset to increase values associated with said second dataset, said values each associated with an attribute characteristic content or data object of said second dataset and aligned with the class and type of the dataset.

13. A method and system as in claim 8, further comprising registering certain data objects that are associated with the second dataset, wherein said transferring comprises automatically transferring both the second dataset and said data objects using the new unique code.

14. A method and system comprising using an electronic device capable of implementing computer readable code for providing a user access to features of one or a plurality of a website server, a social networking site, or a Wiki or blog, and providing the user with access to one or a plurality of datasets on the one or a plurality of a website server, a social networking site, or a Wiki or blog;
accepting registration information for the one or a plurality a dataset on the website server social networking site or Wiki or blog, and responsive to said additional registration information, providing the user with access to said dataset on said website server social networking site or Wiki or blog, said additional registration information causing the website server social networking site or Wiki or blog to access personalization information about the dataset, including initial characteristics and attributes possessed by the dataset;
providing access to the user according to the level of access rights assigned to the user to edit change or otherwise transform the dataset by changing one or a plurality of said characteristics and attributes through interaction with the dataset on the website server social networking site or Wiki or blog to create a set of custom characteristics and attributes for the dataset;
calculating an estimated market value for the dataset based upon previous completed transfers of similar datasets with said custom attributes characteristics content and data objects and a projected popularity of the dataset in consideration of said custom attributes characteristics content and data objects and a class and type of the dataset;
providing the estimated market value, price, auction value, or reward or bounty value of the dataset to the user;
listing the dataset for sale on the website or server, and responsive to said listing, preventing changes to the dataset by the user and also granting the user access to a portion of the website server social networking site or Wiki or blog for trading a unique version of the dataset as unique due to said changing of said custom attributes characteristics content and data objects to another user, said function providing a unique code to a user which, when said unique code is entered, causes said unique version of the dataset to be registered;
determining if the dataset has lost popularity or interest;
and decreasing said estimated market value for the dataset if the dataset is determined to have lost popularity of interest.

15. A method and system as in claim 14, wherein said registration information comprises a unique code, and further comprising deactivating the unique code after the dataset is transferred to said another user, and replacing the unique code after said deactivating with a second unique code and providing said second unique code to said another user.

16. A method and system as in claim 14, wherein said providing access comprises modifying the dataset to increase values of said characteristics and attributes.

17. A method and system as in claim 14, further comprising allowing the user to register certain characteristics attributes content or data objects that are associated with the dataset, wherein said transferring comprises transferring both the dataset and said characteristics attributes content or data objects.

18. A method and system as in claim 14, further comprising allowing a user to register on the website, server, social network site or Wiki or blog and to select a service or access level to one or a plurality of datasets:
enabling the user to indicate whether the server website social network application or Wiki or blog will push changes in a dataset assigned to the user's registration code or;
enabling the user to access one or a plurality of datasets or classes or types of datasets for viewing in real time;
enabling the user to access one or a plurality of datasets or classes or types of datasets for editing;
enabling the user to access one or a plurality of datasets or classes or types of datasets for viewing in time delimited intervals;
enabling the user to access one or a plurality of datasets or classes or types of datasets for viewing in one or a plurality of tabular formats;
enabling a user to select the level of service or access;
and assigning the said selections to the registration code associated with the user of the website, server, social network application, or Wiki or blog.

19. A method and system as in claim 14, wherein said accepting registration information comprises receiving entry of a unique code that is associated with the second dataset and is entered into an electronic device capable of implementing computer readable code, where the unique code as entered is uniquely identified with the second dataset, and where use of the unique code when entered causes information indicative of the second dataset to be obtained from a table of classes and characteristics and attributes associated with the second dataset, wherein said trading or selling comprises deactivating the unique code to prevent using the unique code to access the second dataset by entering the unique code, providing a new unique code to the second user when said new unique code is entered into an electronic device capable of implementing computer readable code.

20. A method and system as in claim 1, wherein said registering comprises receiving entry of a unique code that is associated with the dataset and is entered into an electronic device capable of implementing computer readable code, where the unique code as entered is uniquely identified with the dataset, and where use of the unique code when entered causes information indicative of the dataset to be obtained from a table of classes and characteristics and attributes associated with the dataset, and where said transferring comprises deactivating the unique code to prevent the first user from using the unique code to access the second dataset by entering the unique code, and providing a new unique code to the second user to access the second dataset when said new unique code is entered into an electronic device capable of implementing computer readable code.
